(19) United States
(12) Patent Application Publication
(10) Pub. No.: US 2005/0242021 A1
(43) Pub. Date: Nov. 3, 2005

(54) Hollow fibres

(75) Inventors: Jerome Ditter, Santa Ana, CA (US); Heinz-Joachim Muller, Thornleigh (AU); Daniel Mullette, Toongabbie (AU)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hillss, NY (US)

(21) Appl. No.: 10/510,033

(22) PCT Filed: Apr. 15, 2003
(86) PCT No.: PCT/US03/11507

§ 371 Date: Jun. 23, 2005

Related U.S. Application Data
(60) Provisional application No. 60/372,456, filed on Apr. 16, 2002.

(51) Int. Cl. B01D 69/08

(52) U.S. Cl. 210/500.23; 210/500.41; 210/500.27; 96/10; 264/41

(57) ABSTRACT

Elongate hollow fibre polymeric membranes having an outer surface, a plurality of pores and a pore size gradient increasing radially inwardly such that the pores form a substantially hollow passage in the fibre are disclosed. The hollow fiber membranes are made by mixing a liquid lumen forming agent with a polymer dope, and then contacting the dope with a quench fluid for a time sufficient for the dope to solidify, wherein the quench fluid is contacted only at an outer surface of the dope corresponding with an outer surface on the hollow fibre.

### CROSS REFERENCE TO RELATED APPLICATION

This application claims the benefit of U.S. Provisional Application Ser. No. 60/372,456, filed Apr. 16, 2002, the entire content of which is hereby incorporated by reference in this application.

### FIELD OF THE INVENTION

The present invention relates to hollow fibre membranes having a self-formed lumen, and to compositions and methods for forming such hollow fibre membranes.

### BACKGROUND

Synthetic membranes are used for a variety of applications including desalination, gas separation, bacterial and particle filtration, and dialysis. The properties of the membranes vary depending on their morphology, i.e., properties such as cross-sectional symmetry, pore size, pore shape and the polymeric material from which the membrane is made. Different pore size membranes are used for different separation processes, ranging progressively from the relatively large pore sizes used in microfiltration, then ultrafiltration, nanofiltration, reverse osmosis, and ultimately down to gas separation membranes with pores the size of gas molecules. All these types of filtration are pressure driven processes and are distinguished by the size of the particle or molecule that the membrane is capable of retaining or passing. Microfiltration can remove bacteria and very fine particles, including colloidal particles, that are in the micrometer and sub-micrometer range. The various filtration ranges overlap, but as a general rule microfiltration can filter particles down to about 0.05 μm. Ultrafiltration pores are even smaller, while gas separation membranes have extremely small pores and separate on the basis of molecular size as well as the relative absorption characteristics of the various gases.

In filtration processes, the larger the surface area the greater the flow volume that can be achieved. One well known technique for improving the surface to volume ratio is to make membrane filters in the form of hollow fibres, which can be formed into a large bundle and placed inside a suitable cylindrical container. Modules of such hollow fibres have extremely large surface areas per module volume.

Each hollow fibre membrane has a permeable skin on its outer surface and a larger pore support layer beneath the skin. The liquid to be purified, generally water, flows outside the fibre, permeates the pores of the membrane, and flows into the central lumen, where it is drawn off. In practice, several thousand of these hollow fibres are packed into a bundle, which is then enclosed to form a filter module. High surface areas can be achieved in this way without requiring large external volumes.

The process by which membranes are made consists of casting a given formulation, or “dope”, either as a flat film on a support or as an extruded fibre, which is then transformed into a membrane by a gelation process. Gelation is accomplished by using one or more of the following techniques:
immersion in a non-solvent liquid (usually water);
evaporation of volatile components:
imbibition of water vapor;
thermal quenching (temperature drop).

Generally a formulation consists of one or more polymers, one or more solvents, and one or more non-solvents, but other additives, e.g., viscosity enhancers, are also frequently included. The overall process is referred to as a “phase inversion” because it involves a change from a homogeneous solution (solvent-rich phase) into a polymeric network (polymer-rich phase), from which the membrane emerges. The non-solvent in the formulation serves as the pore-forming agent.

Prior to the present invention, the fabrication of a hollow fibre has required simultaneous extrusion of the dope and a lumen fluid (liquid or gas), the latter of which forms the hollow core and serves the same gelling function as the external quenching fluid. Quenching fluids can be modified thermally or compositionally, e.g., by adding some solvent to the liquid quench or water vapor to a gas quench with the aim of enlarging the membranes pores.

The precipitated polymer forms a porous structure containing a network of uniform pores. Production parameters that affect the membrane structure and properties include the polymer concentration, the precipitation media and temperature and the amount of solvent and non-solvent in the polymer solution. These factors can be varied to produce microporous membranes with a large range of pore sizes ranging from less than 0.05 to 20 micrometers, and these membranes possess a variety of chemical, thermal and mechanical properties. Microporous phase inversion membranes are particularly well suited to the removal of viruses, bacteria, and small particulate matter. Of all the various membrane module configurations, e.g., pleated cartridges, plate-and-frame units, impregnated tubes, etc., hollow fibre membrane modules yield the largest membrane area per unit volume.

Certain membranes are asymmetric, meaning they have a gradation in pore size in their cross-section, which in a hollow fibre is the area between the outer skin and the lumen. Asymmetric hollow fibre membranes can be prepared from pre-cursor solutions by Diffusion Induced Phase Separation (DIPS).

The DIPS process is the most common method of preparing hollow fibre membranes and the current method of production of these is herein described in a simplified form.

The polymer precursor material is dissolved in a suitable solvent and then passed through an annular co-extrusion head. The axial passageway in the centre of the head contains a lumen forming fluid. A concentric passageway disposed about the axial passageway contains the homogeneous mixture of the polymer and solvent system. A further outer concentric passageway contains a quench fluid. Under carefully controlled thermal conditions, the three fluids are conducted at a predetermined flow rate into a quench bath at a predetermined temperature. The polymer solution, consisting of the solvent system and at least one polymer, comes into contact with the lumen forming fluid on the inside and with the quench fluid or quench bath solution on the outside. The solvent in which the polymer is dissolved diffuses from the polymer mixture into the lumen fluid on the inside of the fibre, and into the fibre-forming fluid on the outside of the fibre, while the quench fluid simultaneously diffuses into the extruded polymer mixture as it forms. After a given period of time, the exchange of the non-solvent and solvent has proceeded to such an extent that the solvent dope mixture becomes thermodynamically unstable and demixing occurs.

With rapid gelling (hydrophobic) polymers, e.g., the polysulfone family, the rate and speed of de-mixing occurs faster at the outer surface of the membrane and slower further away from the interface, due to decreasing diffusion rates in the interior of the forming membrane. This results in a pore size gradient with smaller pores at the surface and larger pores further inwards. The pores at the interface of these membranes, which in a hollow fibre are the outer layer of the fibre and the wall of the lumen are very small and create a very thin “skin” region, which is on the order of about one micron thick and is the critical region for filtration. Thus, the outside of the fibre and the lining of a lumen have smaller pores than the region sandwiched between the two surfaces. A schematic representation is shown in FIG. 1.

Slow gelling polymers, such as nylon-6/6, do not form asymmetric membranes because the rate of gelation and the rate of diffusion are about equal. Asymmetry can also be reduced in normally rapidly gelling polymers by adding a solvent to the quench bath to slow the gelling process.

Water can be forced through the pores of a hydrophobic membrane by the imposition of sufficiently high pressures. However, for very small pore sizes the pressure required may be so high as to cause damage to the membrane. In a typical membrane, with a range of pore sizes, the smaller ones wet last under imposed pressures and consequently may prevent total wetting of the membrane during filtration. Frequently hydrophobic membranes are hydrophilised by addition of a wetting agent like hydroxypropyl cellulose to promote wetting and hence permeability.

Some hydrophilic polymers may be unsuitable for the fabrication of microfiltration and ultrafiltration membranes where high mechanical strength and thermal stability are needed, since water in these instances may act as a plasticiser.

Currently, poly(tetrafluoroethylene) PTFE, polyethylene PE, polypropylene PP, poly(vinylidene fluoride) PVDF and polysuifone polymers are the most widely used hydrophobic membrane materials. Polysulfone polymers include for example, polysulfone, polyethersulfone and polyphenylsulfone.

The apparatus required to form polymeric hollow fibre membranes is expensive and requires the use of complex dies and the need to regulate the solvent, the flow rate, the temperature, the aperture size and also the polymer solvent and quench and lumen balances.

Alternative procedures exist to produce asymmetric membranes but these involve laying down membranes with the properties discussed above onto a pre-formed microporous membrane support. These methods however are very difficult for hollow fibre membranes.

It is an object of the present invention to overcome or ameliorate at least one of the above mentioned disadvantages in the prior art.

### DESCRIPTION OF THE INVENTION

According to a first aspect the invention provides an elongate hollow fibre polymeric membrane having an outer surface, a plurality of pores and a pore size gradient increasing radially inwardly such that said pores form a substantially hollow passage in said fibre.

Preferably, said pores are convergent at a point radially inwardly of the outer surface.

Preferably the substantially hollow passageway is disposed around a longitudinal axis of said hollow fibre polymeric membrane.

Preferably the polymeric membrane material is any polymeric material which forms an asymmetric membrane.

According to a second aspect, the invention provides a method of forming a hollow fibre including the steps of:
mixing a liquid lumen forming agent with a polymer dope;
contacting said dope with a quench fluid for a time sufficient to solidify said dope; and wherein said quench fluid is contacted only at an outer surface of said dope corresponding with an outer surface of said hollow fibre.

Preferably, the liquid lumen forming agent is less than 100% soluble in water and greater than 0%. Most preferably, the solubility of the liquid lumen forming agent is around 10% in water.

Preferably, the liquid lumen forming agent has a LogK_{ow} (Log of partition coefficient in octanol/water) of between 0 and 1.5, more preferably between 0.75 and 0.95 and most preferably around 0.8.

Preferably, the liquid lumen forming agent is one or more of (but not limited to) cyclohexanone, ethoxy propylacetate (EPA), methoxypropylacetate (PMA) from B P Amoco®, and a dibasic ester (DBE) from DuPont®.

The polymer dope can contain as a fibre forming agent any conventional fibre-forming polymer, such as polysulfone (PSU), polyethersulfone (PES) and polyphenylsulphone (PSU), and can contain any solvent for these, such as N-methylpyrrolidone. In general terms, the membrane dope is any dope which forms an asymmetric membrane.

The polymer dope may also contain the Paphen® phenoxy resins such as PKHM-85X, PKHW-34, PKHC, PKHH, PKHJ, PKFE, PKHS-30PMA, PKHS40, PKHW-35, PKHM-30, PKHM-301, PKHM-85, PKBP-200 manufactured by Phenoxy Specialties (a division of InChem corp).

These are compounds with ether linkages and pendant hydroxy groups. They can be, for instance, phenol, 4,4′-(-methylenediamine) bispolymer with chloromethyloxirane, or modified phenoxy resins or dimethylethanolamine salts thereof.

PKHS-30PMA, for instance, has the following structure:

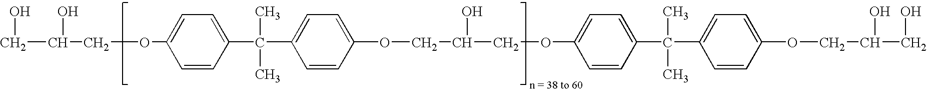

Other additives may also be present, such as, for example, elasticity enhancing agents. A preferred additive is Kynar FLEX 2800 which may optionally be present in an amount of about 1%.

The quench liquid can be any hydrophilic non-solvent for the polymer. Water is particularly preferred.

According to a third aspect the invention provides a hollow fibre polymeric membrane having an outer surface formed at a dope/non-solvent interface of a diffusion induced phase separation process and an inner lumen formed by convergence of membrane pores about a hydrophobic liquid lumen forming agent.

### BRIEF DESCRIPTION OF THE DRAWINGS

FIG. 1 shows a schematic cross section of a hollow fibre membrane of the prior art showing pore size distribution.

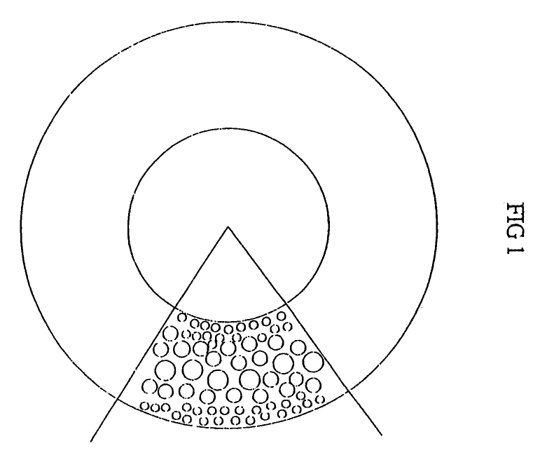

FIG. 2 shows a schematic cross section of a hollow fibre membrane of the present invention showing pore size distribution.

FIG. 3 shows photomicrographs of hollow fibre membranes of the present invention.

The present invention provides for the manufacture of polymeric hollow fibres without using the known method of adding a non-solvent lumen fluid directly to the core of an extruding polymer dope mixture. The structure of the fibres of the present invention have a centre core with a relatively open but somewhat fuzzy structure, where the centre core is effectively empty because the polymer concentrates in the outer shell and becomes increasingly less concentrated toward the centre core. Put conversely, the pores at the surface of the fibre are small and tightly packed, but increase in size toward the centre of the fibre so that they reach a point where they converge to provide substantially hollow passageway. In this regard, they have a lumen, although the lumen is self-formed or self-propagated by the selection of certain agents which are used in the dope, rather than formed through the use of co-extrusion of a separate core of lumen forming non-solvent.

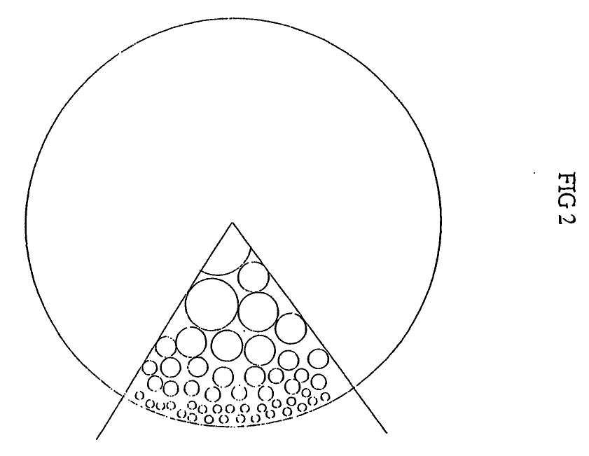

A schematic representation of membranes prepared according to the present invention is illustrated in FIG. 2.

In flat sheet asymmetric membranes, the pores on the open side are typically in the order of 100 times larger than the pores on the tight side. A similar feature is seen in the hollow fibres of the present invention the pores on the outside of the fibre are small and tight, and the pores on the inside become increasingly larger, to the point where they converge and form an interior open cavity which has a free-form surface.

Thus, this method of forming hollow fibre membranes is suitable for any membrane forming mixture known to form asymmetric membranes. Without wishing to be bound by theory, it is believed that the lower the crystallinity of the polymer, the more likely it is to form an asymmetric membrane, ie, totally amorphous polymers usually form asymmetric membranes.

Such self lumen-forming dope mixes are in fact highly desirable because it is significantly easier to make hollow fibres without the separate co-addition of a lumen forming fluid in the centre of an extruding dope mixture.

Not only is the approach much simpler, but also less adjustment to flow, concentration, contact times and distances etc is required.

As mentioned above, in the DIPS (Diffusion Induced Phase Separation) process a solution consisting of a suitable polymer and a solvent (a dope) is brought into contact with a non-solvent, causing the solvent to diffuse outward and the non-solvent inward.

The composition of the solution changes and becomes unstable as soon as the solution reaches a composition inside the binodal, causing the polymer to precipitate. For example, a polymer dope solution containing PES (polyethersulfone) in a solvent like N-methylpyrrolidone (NMP) is precipitated by exposure to water, in which PES is insoluble.

As the precipitation commences, NMP and water exchange because NMP is water-soluble. In the present invention, a hydrophobic solvent such as cyclohexanone is added to the dope. Without wishing to be bound by theory, it is believed that this solvent moves away from the water towards the centre of the hollow fibre. The solvent is hydrophobic, but not incompatible with water.

During this process the polymer membrane precipitates in such a way that small pores form on the outside while pore size progressively becomes larger towards the centre. This is called an asymmetric membrane. The membrane is so asymmetric that the central pores combine to form a channel or Lumen.

### DESCRIPTION OF THE PREFERRED EMBODIMENTS

A standard membrane dope is as follows:
15% PBS—polyether sulfone
10% PVP K90—polyvinylpyrrolidone
75% NMP—N-methylpyrrolidone

This formulation was injected using a syringe into hot (90° C.) water bath quench—there was no self-formation of lumen observed.

The standard membrane dope formulation was treated with cyclohexanone and that was found to give a self formed lumen. The composition was:
15% PES
10% PVP
28% Cyclohexanone
47% NMP

When producing fibres of the present invention via the DIPS process, a number of parameters need be considered, such as use of an air gap or a steam tube, quench bath temperature, and the speed of the dope and winder. Variation of these parameters will lead to different fibre structures. In the present case, the following parameters were found to provide useful results:
Small air gap
Water bath temperature>60° C. (−80° C.)

The diameter of the fibres cast by the present method was around 30 mils (30/1000 inch, or 0.75 mm) diameter, although a range of sizes can be used, depending on the application required. Those skilled in the art are readily able to adjust dope concentrations etc to prepare various thickness membranes. The parameters for preparing a fibre of a certain diameter are similar to those for preparing a flat sheet membrane with a thickness corresponding to the radius of the fibre.

In the trials described below, the fibres that gave the best results had fibre dimensions around 1000-1200 μm outer diameter (OD) and about 600 μm inner diameter (and correspondingly, a wall thickness of about 200-300 μm). These dimensions are fairly standard for those found in the art, where fibre sizes are typically of the order of 500-1000 μm OD. In the case of the present invention, there appears to be no particular upper limit on the size of the fibres produced by the present invention. Without wishing to be bound by theory, the reason the larger sizes appear to be able to form a lumen as well as the smaller size is that in either case there is sufficient time for the solvent to escape to the centre of the lumen before the quench fluid catches up. In this regard, there is a possibility that very small fibres may present a special problem if they quench too fast and there is not enough time for the lumen to form properly.

Cyclohexanone Trials

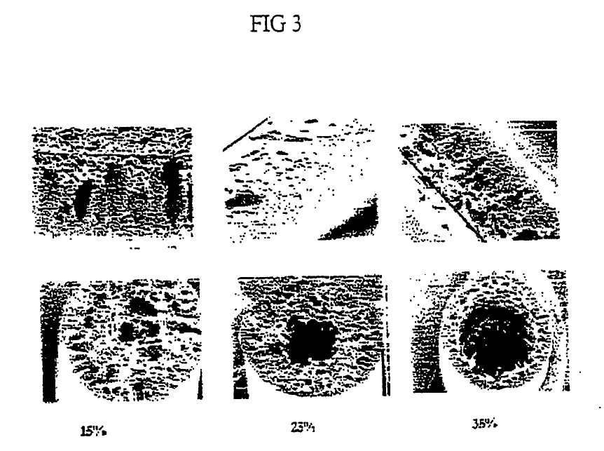

A number of pilot trials were run using cyclohexanone dopes. FIG. 3 shows a number of photomicrographs which illustrate the effect of changing the cyclohexanone concentration. Analysis of these fibres shows that a lumen has formed, with the fibres possessing a break extension averaging ˜15% with a break force averaging 1.5 N.

It was important to ensure that the quench bath was of a sufficient depth to completely solidify the fibres. When the fibres were run into a 5.1 meter deep water (coagulation) bath they completely solidified, whereas an 0.8 meter bath was found to be generally insufficient for complete solidification.

The initial trial run in the 5.1 meter bath was 12% PBS, 12% PVP, 25% cyclohexanone, 51% NUT, with a quench temperature of ˜50° C. Another run employed 15% PES, 5% PVP, 27% cyclohexanone, 53% NMP, also at ˜50° C.

Normally when hollow fibres are produced coagulation will start on both the inside and outside of the fibre since a lumen solution is used to coagulate the fibre on the inside. If no lumen solution is used, only the outside of the fibre will solidify, leaving the middle still liquid.

Post treatment of the fibres was typical for ultrafiltration membranes. After soaking in water for approximately 1 hour the fibres were soaked in a 15% Glycerol solution for several hours depending on sample size. This prevented the pores from collapsing.

While good results were initially obtained using cyclohexanone, it has the significant drawback that it has a pungent odour typical of aldehydes and ketones. This odour can cause headaches and nausea during and after exposure. Ideally, the membrane can be prepared using “green” solvents.

Suitable replacements for cyclohexanone were established using solubility parameters as a starting guide. Solubility parameters take into account functional groups, density, boiling point and model intermolecular forces accordingly. Polar (δₚ) Hydrogen (δ_{b}), and Dispersion (δ_{d}) forces are tabulated and diagrams are plotted to compare various solvents.

The requirements for a suitable solvent are:
1) It is mildly hydrophobic (˜10 w.′% in water)
2) Compatible with the dope mix and the primary solvent (NMP)
3) No effect upon the viscosity of the dope

The solvents found to be most suitable are those with an appropriate range of solubility in water (ca 5-20%), while at the same time being a relatively poor solvent for the polymer mixture. While the lumen forming compounds need to be relatively poor solvents for the polymer they must at the same time not be a non-solvent, i.e., they should not cause the polymer to precipitate prematurely from the polymer dope.

While it is not possible to describe all these identified characteristics of the liquid lumen-forming agent with a single parameter, the best indicators are the solubility in water and the octanol/water partition coefficient.

Preferably, the liquid lumen-forming agent has a LogK_{ow} (Log of partition Coefficient in octanol/water) of between 0 and 1.5, more preferably between 0.75 and 0.95 and most preferably around 0.8.

The only characteristics that all the lumen forming solvents have shown is their solubility in water. Preferably, the water solubilities are <100% and >0%. Most preferably, the solubility of the liquid lumen-forming agent is around 10%.

Other additives found to be useful in the present invention include PEG, H₂O, isopropanol, propylene carbonate, S630 (PVP/PVAc), Lutonal (PVEE), polyvinylacetate (PVAc), DBE (dimethylsuccinate, dimethylglutarate, dimethyladipate), DBE-3, DBE-6, Citroflex (2, A-2, A4), and Surfadone (N-octylpyrrolidone).

DuPont's DBE's have the following structures

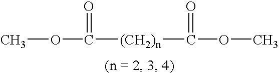

Table 1 shows a series of tests illustrating the ranges of mixtures which may be employed in accordance with the present invention to produce hollow fibres without the use of a separate lumen forming fluid.

Microfiltration fibres with up to about 18% polysulfone and 15% PVP have been prepared.

Turning to the other production parameters, an air gap is the distance the fibre forming dope is exposed to air before it reaches the quench liquid. The air gap and/or the use of a steam tube in the process are aimed at improving the flow properties of the membrane by inducing the formation and/or enlargement of the surface pores to improve the membrane's permeability during filtration. It also encourages the dope to initiate gelation prior to the main quench to try to increase the asymmetry of the membrane.

Without wishing to be bound by theory, it is believed that the hollow fibre forms because the liquid lumen-forming agent has relatively low solubility in water (typically around 10-20%) and is forced inwardly by the encroaching quench liquid, ending up in the centre of the fibre and thereby forming the lumen. Residual polymeric material in the lumen has been reduced to negligible amounts so that further solidification can no longer occur.

Eventually the quench fluid does reach the liquid lumen-forming agent and the two admix. The liquid lumen-forming agent eventually dissolves in the water quench.

The bursting of the fibre as it is forming when unsuitable liquid lumen forming agents are used appears related to the degree of hydrophobicity of the liquid lumen forming agent. The greater the hydrophobicity of the liquid lumen forming agent, the more likely the fibres are to burst during formation because the degree of repulsion by water is stronger. As the fibres form they shrink slightly, thereby increasing the pressure on the inside of the fibre. If the precipitation rate is slow (as with a non-water soluble solvent) then the fibres are softer for a longer period, and therefore the propensity of the system to be damaged is higher.

Thus, it is important to select a liquid lumen forming agent which is sufficiently hydrophobic to form a lumen but not too hydrophobic to induce fibre burst.

Preferably, the liquid lumen-forming agent is cyclohexanone, ethoxypropylacetate (EPA) or methoxypropyl Acetate (PMA) from BP Amoco and a dibasic ester (DBE) from DuPont, but is not limited to those reagents.

Polysulfone PSU, used to exemplify the invention above, can be replaced with other commonly used fibre forming agents, such as polyethersulfone (PBS) and polyphenylsulphone (PPSU) as well.

Cartridges of fibres of the present invention can be made in the usual way by potting large bunches of fibres inside cylindrical containers and cutting off the tips. The fibres are structurally quite strong when pressured from the outside, so hydrophilicity can be imparted (after potting) even to very tight membranes by impregnating with an HPC (hydroxypropyl cellulose) or PVP (polyvinylpyrrolidone) solution at high pressures. Smaller pore flat sheet membranes are generally not amenable to such treatment except by application of equal pressures on both sides and while under vacuum to preclude entrapment of air in the membrane's pores.

The hollow fibres of the present invention have broad applicability, including general microfiltration and ultrafiltration, sensor applications (which employ a small number of short fibres), blood plasma separation and substrates for reverse osmosis, and nanofiltration membranes. Reverse osmosis and nanofiltration membranes may require impregnation with a thin separation film on the outside of the membrane fibre.

It will be appreciated by those skilled in the art that the present invention extends beyond the specific embodiments provided by way of example.

TABLE 1
SUMMARY OF HOLLOW FIBRE FORMATION OF THE PRESENT INVENTION

| Membrane | Poly- | | Copoly- | | Copolymer | | Lumen | | | | % | | |
|---|---|---|---|---|---|---|---|---|---|---|---|---|---|
| Type | mer | % | mer 1 | % | 2 | % | Former | % | Additive 1 | % | NMP | Lumen | Comments |
| Extruded Fibre | PES | 14 | PVP K-90 | 14 | | | | | | | 72 | Yes | Lumen in some fibres. |
| Extruded Fibre | PES | 10 | PVP K-90 | 10 | | | Cyclohexanone | 25 | | | 55 | Yes | LUMEN OBTAINED. |
| | | | | | | | | | | | | | Highly asymmetric |
| Extruded Fibre | PES | 10 | PVP K-90 | 10 | | | Cyclohexanone | 35 | | | 45 | Yes | LUMEN OBTAINED. |
| | | | | | | | | | | | | | Highly asymmetric |
| Extruded Fibre | PES | 15 | PVP K-90 | 10 | | | Cyclohexanone | 28 | | | 47 | Yes | LUMEN OBTAINED. |
| | | | | | | | | | | | | | Highly asymmetric |
| Extruded Fibre | PES | 10 | PVP K-90 | 10 | | | DBE | 25 | | | 55 | Yes | Highly asymmetric. Lumen |
| | | | | | | | | | | | | | in some fibres |
| Extruded Fibre | PES | 15 | PVP K-90 | 8 | S-630 | 3 | Cyclohexanone | 25 | | | 49 | Yes | Lumen obtained |
| Syringed | PSU | 15 | PVP K-90 | 10 | | | EPA | 28 | | | 47 | Yes | Lumen present - good |
| (solid) Fibre | | | | | | | | | | | | | fibre dimensions |
| Syringed | PSU | 15 | PVP K-90 | 10 | | | EPA | 24 | PEG200 | 10 | 41 | Yes | Lumen present - |
| (solid) Fibre | | | | | | | | | | | | | good fibre dimensions, |
| | | | | | | | | | | | | | some larger fibres had a ‘core’ |
| Syringed | PSU | 15 | PVP K-90 | 10 | | | EPA | 24 | Propylene | 10 | 41 | Yes | Lumen present - |
| (solid) Fibre | | | | | | | | | Carbonate | | | | good fibre dimensions, |
| | | | | | | | | | | | | | some larger fibres had a ‘core’ |
| Syringed | PSU | 17 | | | | | EPA | 31 | | | 52 | Yes | Smaller lumen than |
| (solid) Fibre | | | | | | | | | | | | | with K90/15%. |
| Syringed | PSU | 15 | PVP K-90 | 10 | UW1 | 5 | | | | | 70 | Yes | Fibres collapsed on |
| (solid) Fibre | | | | | | | | | | | | | drying (ie squashed). |
| | | | | | | | | | | | | | Tried to add 44% NMP |
| | | | | | | | | | | | | | before adding PGDA (26%) |
| | | | | | | | | | | | | | but the dope would not mix. |
| | | | | | | | | | | | | | Added an additional |
| | | | | | | | | | | | | | 13% NMP and the dope |
| | | | | | | | | | | | | | went from not mixed to a |
| | | | | | | | | | | | | | creamy thick consistency. |
| | | | | | | | | | | | | | Added another 11% |
| | | | | | | | | | | | | | (70% total) NMP to the |
| | | | | | | | | | | | | | dope. Appears to have |
| | | | | | | | | | | | | | a higher flexibility than PS |
| Syringed | PSU | 15 | PVP K-90 | 10 | | | Dowanol PMA | 28 | | | 47 | Yes | Dope was slightly cloudy, |
| (solid) Fibre | | | | | | | | | | | | | no problems mixing. |
| | | | | | | | | | | | | | Fibres precipitated |
| | | | | | | | | | | | | | quickly confirming proximity |
| | | | | | | | | | | | | | to cloud point. |
| | | | | | | | | | | | | | SEMs showed extreme |
| | | | | | | | | | | | | | asymmetry in 1050 μm |
| | | | | | | | | | | | | | fibres but a lumen in |
| | | | | | | | | | | | | | 1220 μm fibres. |

1. An elongate hollow fibre polymeric membrane having an outer surface, a plurality of pores and a pore size gradient increasing radially inwardly such that said pores form a substantially hollow passage in said fibre:

2. The hollow fibre membrane of claim 1, wherein said pores are convergent at a point radially inwardly of the outer surface.

3. The hollow fibre membrane of claim 1, wherein the substantially hollow passage is disposed around a longitudinal axis of said hollow fibre polymeric membrane.

4. The hollow fibre membrane of claim 1, wherein the polymeric membrane material is a polymeric material which forms an asymmetric membrane.

5. A filtration cartridge comprising a plurality of hollow fibre membranes according to claim 1.

6. A method of making an elongate hollow fibre polymeric membrane comprising:
(i) mixing a liquid lumen-forming agent with a polymer dope;
(ii) contacting said dope with a quench fluid for a time sufficient to solidify said dope; and wherein said quench fluid is contacted only at an outer surface of said dope corresponding with an outer surface of said hollow fibre.

7. The method of claim 6, wherein the liquid lumen-forming agent is greater than 0% and less than 100% soluble in water.

8. The method of claim 7, wherein the solubility of the liquid-lumen forming agent is around 10% in water.

9. The method of claim 6, wherein the liquid lumen-forming agent has a log of partition coefficient in octanol/water (LogK_{ow}) of between 0 and 1.5.

10. The method of claim 9, wherein the liquid-lumen-forming agent has a LogK_{ow} of between about 0.75 and about 0.95.

11. The method of claim 9, wherein the liquid-lumen forming agent has a LogK_{ow} of about 0.8.

12. The method of claim 6, wherein the liquid lumen-forming agent is at least one selected from the group consisting of cyclohexanones, ethoxy propylacetates (EPA), methoxypropylacetates (PMA) and dibasic esters (DBE).

13. The method of claim 6, wherein said polymer dope comprises a fibre-forming polymeric material which forms an asymmetric membrane.

14. The method of claim 13, wherein the polymer dope comprises a fibre-forming polysulfone (PSU).

15. The method of claim 14, wherein the fibre-forming polysulfone is at least one selected from the group consisting of polyethersulfones (PES) and polyphenylsulphone (PPSU).

16. The method of claim 15, wherein the polymer dope comprises a N-methylpyrrolidone solvent.

17. The method of claim 6, wherein the polymer dope comprises a phenoxy resin.

18. The method of claim 17, wherein the phenoxy resin comprises ether linkages and pendant hydroxy groups.

19. The method of claim 18, wherein the phenoxy resin comprises phenol, 4,4′-(1-methylenediamine) bispolymer with chloromethyloxirane, modified phenoxy resins or dimethylethanolamine salts thereof.

20. The method of claim 18, wherein the phenoxy resin comprises:

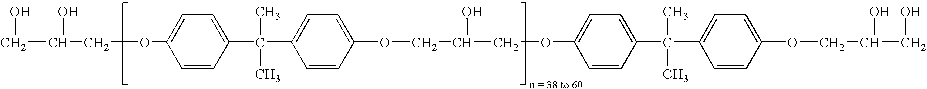

21. The method of claim 6, wherein the dope comprises an elasticity-enhancing additive.

22. The method of claim 6, wherein the quench fluid comprises a hydrophilic non-solvent for the polymer.

23. The method of claim 22, wherein the quench liquid comprises water.

24. An elongate hollow fibre polymeric membrane made by the method of claim 6.

25. A hollow fibre polymeric membrane having an outer surface formed at a dope/non-solvent interface of a diffusion induced phase separation (DIPS) process and an inner lumen formed by convergence of membrane pores about a hydrophobic liquid lumen-forming agent.
